(19) United States
(12) Patent Application Publication
(10) Pub. No.: US 2025/0054743 A1
(43) Pub. Date: Feb. 13, 2025

(54) SAMPLE SUPPORT BODY AND METHOD FOR MANUFACTURING SAMPLE SUPPORT BODY

(71) Applicant: HAMAMATSU PHOTONICS K.K., Hamamatsu-shi, Shizuoka (JP)

(72) Inventors: Masahiro KOTANI, Hamamatsu-shi, Shizuoka (JP); Takayuki OHMURA, Hamamatsu-shi, Shizuoka (JP); Takamasa IKEDA, Hamamatsu-shi, Shizuoka (JP)

(73) Assignee: HAMAMATSU PHOTONICS K.K., Hamamatsu-shi, Shizuoka (JP)

(21) Appl. No.: 18/722,784

(22) PCT Filed: Nov. 4, 2022
(86) PCT No.: PCT/JP2022/041206

§ 371 Date: Jun. 21, 2024

(30) Foreign Application Priority Data
Feb. 16, 2022 (JP) 2022-022001

(51) Int. Cl. H01J 49/04; B05B 5/00

(52) U.S. Cl. CPC H01J 49/0418; B05B 5/00

(57) ABSTRACT

A sample support body is a sample support body used for ionizing components of a sample. The sample support body includes a substrate, a conductive layer, and a plurality of particles. The substrate includes a main surface and a plurality of holes opened in the main surface. The conductive layer is provided on the main surface so that the holes are not blocked. The plurality of particles are provided on a surface of the conductive layer. The absorption rate of the plurality of particles with respect to the energy beam used for ionization is equal to or higher than the absorption rate of the conductive layer with respect to the energy beam.

### TECHNICAL FIELD

The present disclosure relates to a sample support body and a method for manufacturing the sample support body.

### BACKGROUND ART

In the related art, a sample support body for ionizing components of a sample in mass spectrometry of the sample is known (See, for example, Patent Literature 1). Such a sample support body includes a substrate having a first main surface, a second main surface opposite to the first main surface, and a plurality of through holes opened in the first main surface and the second main surface, and a conductive layer provided on the first main surface.

In such mass spectrometry, when the first main surface of the substrate is irradiated with an energy beam such as laser light, the energy is transmitted to the component of the sample on the first main surface side via the conductive layer. As a result, components of the sample are ionized, to generate sample ions. Then, sample ions are detected, and mass spectrometry of the sample is performed based on the detection result.

### CITATION LIST

### Patent Literature

Patent Literature 1: Japanese Patent No. 6093492

### SUMMARY OF INVENTION

### Technical Problem

In the mass spectrometry as described above, energy is transmitted to the components of the sample via the conductive layer, and thus the components of the sample are efficiently ionized. As a result, sample ions are also efficiently detected, and thus improvement in sensitivity (signal intensity) is secured. However, in mass spectrometry, further improvement in sensitivity may be desired.

An object of the present disclosure is to provide a sample support body that enables highly sensitive mass spectrometry and a method for manufacturing the sample support body.

### Solution to Problem

A sample support body according to the present disclosure is a sample support body used for ionizing a component of a sample, the sample support body including: a substrate configured to include a main surface and a plurality of holes opened in the main surface; a conductive layer configured to be provided on the main surface so as not to block the holes; and a plurality of particles configured to be provided on a surface of the conductive layer, in which an absorption rate of the plurality of particles with respect to an energy beam used for the ionization is equal to or higher than an absorption rate of the conductive layer with respect to the energy beam.

The sample support body includes a substrate having a main surface and a plurality of holes opened to the main surface. When the component of the sample is introduced into the plurality of holes, the component remains on the main surface side. When the main surface is irradiated with energy beam while a voltage is applied to the conductive layer, energy is transmitted to the component on the main surface side. The component on the main surface side is ionized by this energy. Here, the plurality of particles are provided on the surface of the conductive layer. The absorption rate of the plurality of particles with respect to the energy beam is equal to or higher than the absorption rate of the conductive layer with respect to the energy beam. Therefore, the energy is efficiently transmitted to the component on the main surface side, whereby the component on the main surface side is efficiently ionized. Therefore, the signal intensity of sample ions generated by the ionization of the component is improved. Therefore, with this sample support body, highly sensitive mass spectrometry becomes possible.

The plurality of particles may be a plurality of nanoparticles deposited on the surface of the conductive layer. As a result, the energy is more efficiently transmitted to the component on the main surface side, and thus more sensitive mass spectrometry becomes possible.

The area corresponding to the plurality of particles may be smaller than the area corresponding to the conductive layer when viewed from a direction perpendicular to the main surface. As a result, the functions of both the conductive layer and the particles can be reliably secured, and thus highly sensitive mass spectrometry as described above can be reliably realized.

The surface of the conductive layer may include a plurality of first regions separated from each other and a second region positioned between the plurality of first regions, the plurality of particles may be provided in each of the plurality of first regions, and the plurality of particles may not be provided in the second region. As a result, the functions of both the conductive layer and the particles can be reliably secured, and thus highly sensitive mass spectrometry as described above can be reliably realized.

The plurality of particles may have absorbability with respect to laser light. As a result, by using the laser light as the energy beam, it is possible to realize the highly sensitive mass spectrometry as described above.

The plurality of particles may have absorbability to ultraviolet rays. As a result, the range of the wavelength band of the energy beam is widened, and thus the degree of freedom in selecting the type of the energy beam can be improved.

The sensitizing action of the plurality of particles with respect to the energy beam may be larger than the sensitizing action of the conductive layer with respect to the energy beam. As a result, the highly sensitive mass spectrometry as described above can be reliably realized.

The material of the plurality of particles may be different from the material of the conductive layer. As a result, the degree of freedom in selecting the respective materials of the conductive layer and the particles can be improved while securing the functions of both the conductive layer and the particles.

The material of the plurality of particles may include a metal element. As a result, the degree of freedom in selecting the material of the particles can be improved while securing the function of the particles having absorbability with respect to the energy beam.

The material of the plurality of particles may be gold, platinum, or titanium dioxide. As a result, the degree of freedom in selecting the material of the particles can be improved while securing the function of the particles having absorbability with respect to the energy beam.

The material of the plurality of particles may include carbon. As a result, the degree of freedom in selecting the material of the particles can be improved while securing the function of the particles having absorbability with respect to the energy beam.

The material of the plurality of particles may be a compound including a metal element or carbon. As a result, the degree of freedom in selecting the material of the particles can be improved while securing the function of the particles having absorbability with respect to the energy beam.

The plurality of particles may be formed by an electrostatic spraying method. As a result, the function of the particles having absorbability with respect to the energy beam can be secured at low cost.

A method for manufacturing a sample support body according to the present disclosure is a method for manufacturing a sample support body used for ionizing a component of a sample, the method including a first step of preparing a substrate that includes a main surface and a plurality of holes opened in the main surface; a second step of providing a conductive layer on the main surface so as not to block the holes; and a third step of providing a plurality of particles on a surface of the conductive layer, in which an absorption rate of the plurality of particles with respect to an energy beam used for the ionization is equal to or higher than an absorption rate of the conductive layer with respect to the energy beam.

According to the method for manufacturing this sample support body, the sample support body that enables highly sensitive mass spectrometry can be manufactured as described above.

In the third step, the plurality of particles may be provided by a wet process. As a result, the particles having absorbability with respect to the energy beam can be reliably formed.

In the third step, a liquid including the plurality of particles may be jetted onto the surface of the conductive layer by an electrostatic spraying method. As a result, the particles having absorbability with respect to the energy beam can be reliably formed at low cost.

### Advantageous Effects of Invention

According to the present disclosure, it is possible to provide a sample support body that enables highly sensitive mass spectrometry and a method for manufacturing the sample support body.

### BRIEF DESCRIPTION OF DRAWINGS

FIG. 1 is a plan view of a sample support body according to one embodiment.

FIG. 2 is a cross-sectional view taken along line II-II illustrated in FIG. 1.

FIG. 3 is an enlarged image of a substrate of the sample support body illustrated in FIG. 1.

FIG. 4 is a schematic view of a surface of the sample support body illustrated in FIG. 1.

FIG. 5 is a schematic view of a cross section of the sample support body illustrated in FIG. 1.

FIG. 6 is an enlarged image of the surface of the sample support body illustrated in FIG. 1.

FIG. 7 is a diagram illustrating steps of a mass spectrometry method using the sample support body illustrated in FIG. 1.

FIG. 8 is a diagram illustrating results of mass spectrometry methods of a first comparative example and a first example.

FIG. 9 is a diagram illustrating results of mass spectrometry methods of a second comparative example and a second example.

FIG. 10 is a diagram illustrating steps of a method for manufacturing the sample support body illustrated in FIG. 1.

FIG. 11 is a diagram illustrating results of mass spectrometry methods of a third comparative example and a third example.

FIG. 12 is an enlarged image of a surface of a sample support body of a modification.

FIG. 13 is an enlarged image of the surface of the sample support body of the modification.

FIG. 14 is a schematic view of a cross section of the sample support body of the modification.

FIG. 15 is a cross-sectional view of the sample support body of the modification.

### DESCRIPTION OF EMBODIMENTS

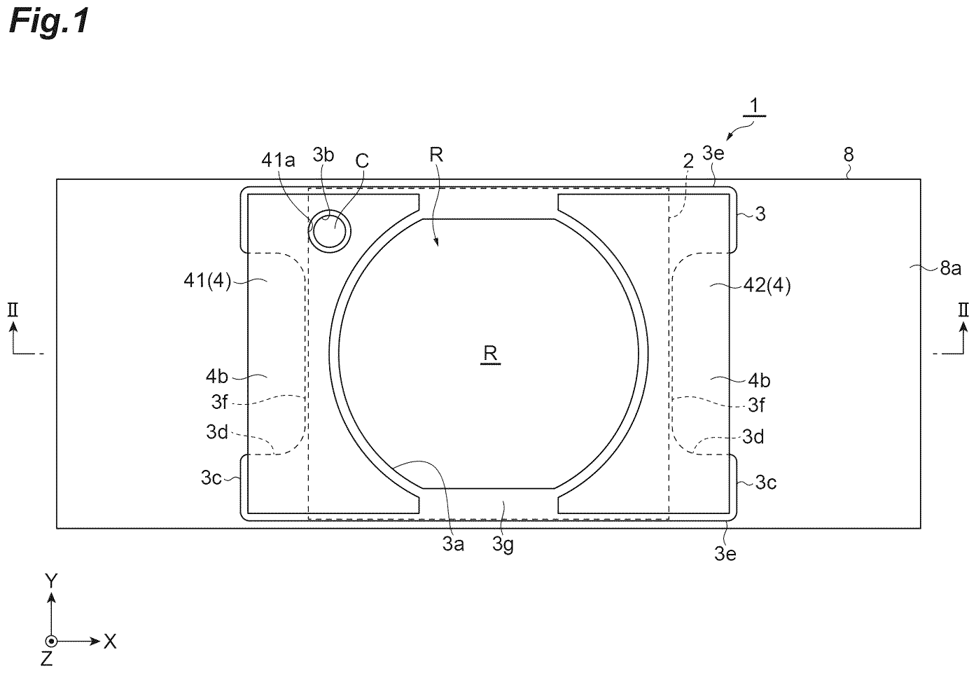

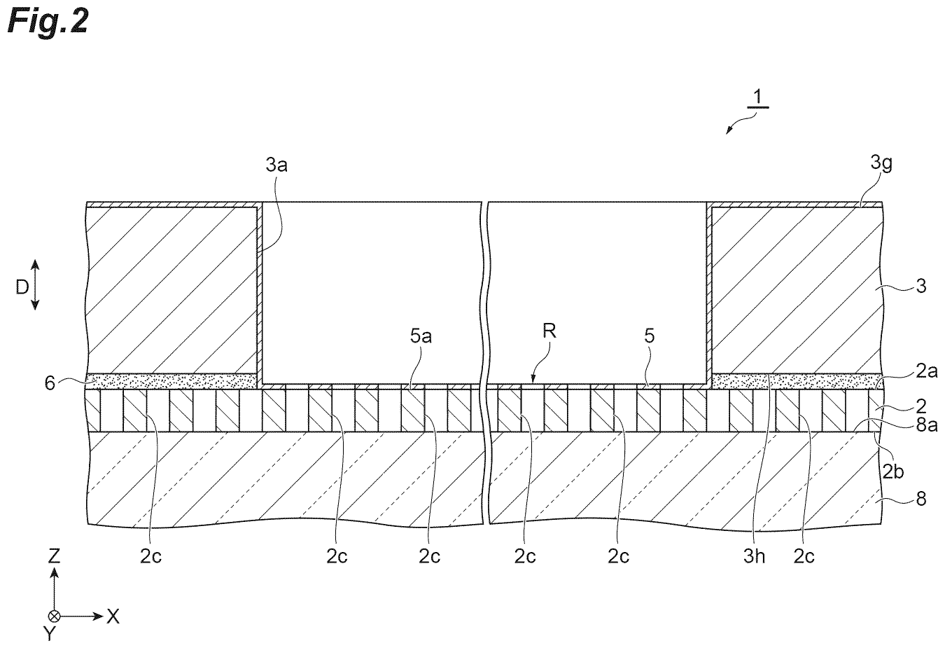

Hereinafter, embodiments of the present disclosure are described with reference to the drawings. The same or corresponding parts in the drawings are denoted by the same reference signs, and repetitive descriptions are omitted.

[Configuration of Sample support body] As illustrated in FIGS. 1 and 2, a sample support body 1 includes a substrate 2, a frame 3, and a conductive layer 5. The sample support body 1 has a substantially rectangular shape in plan view. In the present embodiment, a direction along a long side of the sample support body 1 is represented as an X axis direction, a direction along a short side of the sample support body 1 is represented as a Y axis direction, and a thickness direction of the sample support body 1 is represented as a Z axis direction. The length of the sample support body 1 in the X axis direction is, for example, about 3 cm. The length of the sample support body 1 in the Y axis direction is, for example, about 2 cm.

The substrate 2 has, for example, a rectangular plate shape. The substrate 2 has a first main surface 2a, a second main surface 2b opposite to the first main surface 2a, and a plurality of holes 2c. The length of one side of the substrate 2 when viewed from the thickness direction (direction perpendicular to the first main surface 2a) D of the substrate 2 is, for example, about several cm. The thickness of the substrate 2 is, for example, about 1 μm to 50 μm. In the present embodiment, the thickness of the substrate 2 is 5 μm to 50 μm.

The plurality of holes 2c are formed uniformly (in a uniform distribution) in the substrate 2. Each hole 2c extends along the thickness direction D of the substrate 2 and is open to the first main surface 2a and the second main surface 2b. That is, each hole 2c is a through hole penetrating the substrate 2. A shape of the hole 2c when viewed in the thickness direction D is, for example, a substantially circular shape. The sizes of the holes 2c may be uneven, or the holes 2c may be partially connected to each other. The substrate 2 is formed of an insulating material.

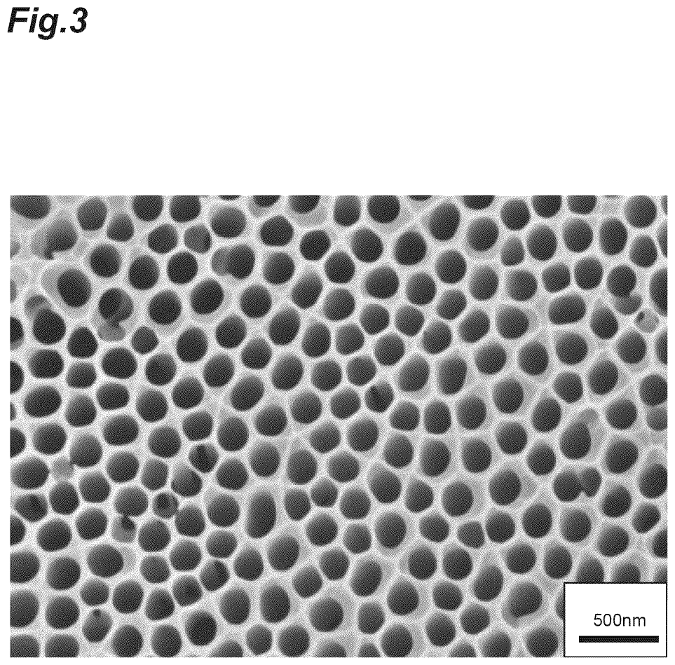

As illustrated in FIG. 3, the plurality of holes 2c having a substantially constant width are uniformly formed in the substrate 2. The substrate 2 illustrated in FIG. 3 is an alumina porous film formed by anodizing aluminum (Al). For example, when an Al substrate is subjected to anodization, a surface portion of the Al substrate is oxidized, and a plurality of pores (portions to become the holes 2c) are formed in the surface portion of the Al substrate. Subsequently, the oxidized surface portion (anode oxide film) is peeled off from the Al substrate, a pore widening process for widening the pores is performed on the peeled anode oxide film, and thus the above-described substrate 2 can be obtained. The substrate 2 may be formed by anodizing a valve metal other than Al, such as Ta (tantalum), Nb (niobium), Ti (titanium), Hf (hafnium), Zr (zirconium), Zn (zinc), W (tungsten), Bi (bismuth), or Sb (antimony) or may be formed by anodizing Si (silicon).

The width of the hole 2c is, for example, about 1 nm to 700 nm. The width of the hole 2c is a value acquired as follows. First, images of the first main surface 2a and the second main surface 2b of the substrate 2 are acquired. FIG. 3 illustrates an example of an SEM image of a part of the first main surface 2a of the substrate 2. In the SEM image, a black portion indicates the hole 2c, and a white portion indicates a partition wall portion between the holes 2c. Subsequently, for example, by performing a binarization process on the acquired image of the first main surface 2a, a plurality of pixel groups corresponding to a plurality of first openings (openings on the first main surface 2a side of the hole 2c) in a measurement region R are extracted, and a diameter of a circle having an average area of the first openings is acquired based on a size per pixel. Similarly, for example, by performing the binarization process on the acquired image of the second main surface 2b, a plurality of pixel groups corresponding to a plurality of second openings (openings on the second main surface 2b side of the hole 2c) in the measurement region R are extracted, and a diameter of a circle having an average area of the second openings is acquired based on a size per pixel. Here, an average value of the diameter of the circle acquired for the first main surface 2a and the diameter of the circle acquired for the second main surface 2b is acquired as the width of the hole 2c.

The frame 3 is provided on the first main surface 2a of the substrate 2. The frame 3 supports the substrate 2 on the first main surface 2a side. The frame 3 has a first surface 3h facing the first main surface 2a of the substrate 2 and a second surface 3g opposite to the first surface 3h. In the present embodiment, the frame 3 is formed in a rectangular plate shape larger than the substrate 2 when viewed from the thickness direction D.

An opening portion 3a penetrating the frame 3 in a thickness direction (that is, the thickness direction D) of the frame 3 is formed in a substantially central portion of the frame 3. An opening portion 3b penetrating the frame 3 in the thickness direction of the frame 3 is formed at a corner of the frame 3. A recess portion 3d recessed inward in the X axis direction is provided in a central portion of an edge portion 3c (that is, an edge portion along the Y axis direction) of the frame 3 in the X axis direction.

The opening portion 3a is formed in a substantially circular shape. In the present embodiment, the opening portion 3a has a shape in which a part of a circle (a portion facing each other in one direction) is cut out in an arch shape. Specifically, the opening portion 3a has a shape in which a part of a circle is cut out in an arch shape such that edge portions on both sides in the Y axis direction are parallel to the X axis direction. As an example, a width of opening portion 3a in the Y axis direction is about 1.5 cm. A portion of the substrate 2 corresponding to the opening portion 3a (that is, a portion overlapping the opening portion 3a when viewed from the thickness direction D) functions as the measurement region R for measuring a sample. That is, the measurement region R is defined by the opening portion 3a provided in the frame 3. In other words, the opening portion 3a opens to the first surface 3h and the second surface 3g so as to correspond to the measurement region R. That is, the frame 3 is formed so as to surround the measurement region R of the substrate 2 when viewed from the thickness direction D.

The opening portion 3b is formed in a circular shape smaller than the opening portion 3a. As an example, the diameter of the opening portion 3b is about 1 mm. A portion of the substrate 2 corresponding to the opening portion 3b (that is, a portion overlapping the opening portion 3b when viewed from the thickness direction D) functions as a calibration region C for calibration.

As described above, the plurality of holes 2c are uniformly formed in the substrate 2, and thus both the measurement region R and the calibration region C are regions including the plurality of holes 2c. An aperture ratio of the holes 2c in the measurement region R (a ratio of the holes 2c to the measurement region R when viewed in the thickness direction D) is practically 10% to 80% and particularly preferably 30% to 60%. The calibration region C is similar to the measurement region R.

The material of the frame 3 is, for example, metal or ceramics. In the present embodiment, the frame 3 is formed of a non-magnetic and acid-resistant material. Examples of the material include titanium and stainless steel (SUS). In the present embodiment, the frame 3 is formed of SUS. An outer shape of the sample support body 1 is mainly defined by the frame 3. The length of the frame 3 in the X axis direction is, for example, about 3 cm. The length of the frame 3 in the Y axis direction is, for example, about 2 cm. The thickness of the frame 3 is, for example, 3 mm or less. As an example, the thickness of the frame 3 is 0.2 mm.

When viewed from the thickness direction D, the substrate 2 is accommodated between a pair of edge portions 3e along the X axis direction of the frame 3 and is accommodated between bottom portions 3f of each of the pair of recess portions 3d of the frame 3. A portion of the substrate 2 except the measurement region R and the calibration region C is fixed to the frame 3 by an adhesive layer 6. Since the substrate 2 is bonded to and supported by the frame 3 in this manner, handling of the sample support body 1 is facilitated, and deformation of the substrate 2 due to temperature change or the like is inhibited.

The adhesive layer 6 is formed between the first main surface 2a of the substrate 2 and the first surface 3h of the frame 3 and adheres the substrate 2 and the frame 3. The adhesive layer 6 can be formed, for example, of an adhesive (for example, low-melting-point glass or a vacuum adhesive) with low emitted gas. The adhesive layer 6 may be formed of a conductive adhesive or may be formed by applying a metal paste. In addition, the adhesive layer 6 may be formed of a UV-curable adhesive (photo-curable adhesive), an inorganic binder, or the like. Examples of the UV-curable adhesive include an acrylic adhesive and an epoxy adhesive. In addition, examples of the inorganic binder include CERAMABOND (registered trademark) manufactured by Audec Corporation and ARON CERAMIC (registered trademark) manufactured by TOAGOSEI CO., LTD. In the present embodiment, as an example, the adhesive layer 6 is formed of the UV-curable adhesive.

The conductive layer 5 is provided on the first main surface 2a of the substrate 2. The conductive layer 5 is continuously (integrally) formed on a region of the first main surface 2a of the substrate 2 corresponding to the opening portion 3a of the frame 3, an inner surface of the opening portion 3a, and the second surface 3g of the frame 3 in a peripheral edge portion of the opening portion 3a. The conductive layer 5 covers a portion of the first main surface 2a of the substrate 2 where the hole 2c is not formed in the measurement region R. The conductive layer 5 is provided so that each hole 2c is not blocked. In the measurement region R, each hole 2c is exposed to the opening portion 3a.

In addition, the conductive layer 5 is also continuously (integrally) formed on a region of the first main surface 2a of the substrate 2 corresponding to the opening portion 3b of the frame 3, an inner surface of the opening portion 3b, and the second surface 3g of the frame 3 in the peripheral edge portion of the opening portion 3b. The conductive layer 5 covers a portion of the first main surface 2a of the substrate 2 where the hole 2c is not formed in the calibration region C. The conductive layer 5 is provided so that each hole 2c is not blocked. Also in the calibration region C, similarly to the measurement region R, each hole 2c is exposed to the opening portion 3b. In FIG. 1, illustration of the conductive layer 5 is omitted.

The conductive layer 5 is formed of a conductive material. The conductive layer 5 is formed of a material suitable for mass spectrometry of a sample. Specifically, the conductive layer 5 is formed of, for example, platinum (Pt) or gold (Au). As the material of the conductive layer 5, metal having low affinity (reactivity) with a sample and high conductivity is preferably used for the following reasons.

For example, when the conductive layer 5 is formed of metal such as copper (Cu) having high affinity with a sample such as protein, the sample is ionized in a state in which Cu atoms are added to sample molecules in a process of ionization of the sample described below, and it is concerned that a detection result may be deviated by the amount of the Cu atoms added in the mass spectrometry described below. Therefore, it is preferable to use metal having low affinity with a sample, as the material of the conductive layer 5.

Meanwhile, as the conductivity of metal is higher, it is easier to stably apply a constant voltage. Therefore, when the conductive layer 5 is formed of metal having high conductivity, a voltage can be uniformly applied to the first main surface 2a of the substrate 2 in the measurement region R. In addition, a metal having higher conductivity tends to have higher thermal conductivity. Therefore, when the conductive layer 5 is formed of metal having high conductivity, the energy of an energy beam with which the substrate 2 is irradiated can be efficiently transmitted to the sample via the conductive layer 5. Hence, a highly conductive metal is preferably used as the material of the conductive layer 5.

From the above-described viewpoint, for example, Pt or Au is preferably used as the material of the conductive layer 5. In the present embodiment, the material of the conductive layer 5 is Pt. The conductive layer 5 is formed, for example, by a known general vapor deposition method. The conductive layer 5 is formed by depositing Pt on the heated substrate 2. Thereby, flatness or uniformity of surface 5a of the conductive layer 5 can be secured. Pt is deposited, for example, under a condition that the degree of vacuum is about 10-+Pa. The conductive layer 5 is a deposited film formed in a film shape. The thickness of the conductive layer 5 is, for example, about 1 nm to 350 nm. The thickness of the conductive layer 5 may be, for example, smaller than 30 nm. As a material of the conductive layer 5, for example, chromium (Cr), nickel (Ni), titanium (Ti), or silver (Ag) may be used. The conductive layer 5 may be formed, for example, by sputtering or the like.

The sample support body 1 is fixed to a slide glass (reinforcing substrate) 8 by a conductive tape 4. The conductive tape 4 is formed of a conductive material. The conductive tape 4 is, for example, an aluminum tape or a carbon tape. The thickness of the conductive tape 4 is, for example, about 50 μm.

The conductive tape 4 is attached onto the second surface 3g of the frame 3. In the present embodiment, the conductive tape 4 is provided on both sides of the frame 3 in the X axis direction. Specifically, the conductive tape 4 includes a conductive tape 41 provided on one side (left side in FIG. 1) of the frame 3 in the X axis direction and a conductive tape 42 provided on the other side (right side in FIG. 1) of the frame 3 in the X axis direction.

The conductive tape 41 is provided on one side (left side in FIG. 1) of the central portion of the frame 3 in the X axis direction so as not to cover the measurement region R and the calibration region C. The conductive tape 41 is provided with a circular opening portion 41a for exposing the calibration region C. In the present embodiment, the edge portions of the conductive tape 41 are slightly separated from the edge portions 3c and 3e of the frame 3, the edge portion of the opening portion 3a of the frame 3, and the edge portion of the opening portion 3b of the frame 3. Meanwhile, the conductive tape 41 is also provided at a position overlapping the space formed by the recess portion 3d of the frame 3 when viewed from the thickness direction D. That is, the conductive tape 41 has a portion 4b (that is, a portion overlapping the space formed by the recess portion 3d) that does not overlap the frame 3 when viewed in the thickness direction D.

The conductive tape 42 is provided on the other side (right side in FIG. 1) of the central portion of the frame 3 in the X axis direction so as not to cover the measurement region R. In the present embodiment, the edge portions of the conductive tape 42 are slightly separated from the edge portions 3c and 3e of the frame 3 and the edge portion of the opening portion 3a of the frame 3. Meanwhile, the conductive tape 42 is also provided at a position overlapping with the recess portion 3d of the frame 3 when viewed from the thickness direction D. That is, the conductive tape 42 has the portion 4b (that is, a portion overlapping the space formed by the recess portion 3d) that does not overlap the frame 3 when viewed in the thickness direction D. The portion 4b of each of the conductive tapes 41 and 42 is attached to a placement surface 8a of the slide glass 8, whereby the sample support body 1 is fixed to the slide glass 8.

The slide glass 8 is a glass substrate on which a transparent conductive film such as an indium tin oxide (ITO) film is formed, and the surface of the transparent conductive film serves as the placement surface 8a. The slide glass 8 is fixed to the substrate 2 so as to cover at least the entire second main surface 2b of the measurement region R of the substrate 2. As an example, the slide glass 8 has a rectangular shape larger than the outer shape of the frame 3 when viewed from the thickness direction D (Z axis direction). That is, all the elements (the substrate 2, the frame 3, and the like) configuring the sample support body 1 described above are accommodated in the slide glass 8, when viewed from the thickness direction D. That is, the slide glass 8 covers not only the measurement region R but also the entire substrate 2. The sample support body 1 is reinforced by the slide glass 8. In addition, as the reinforcing substrate of the sample support body 1, a substrate other than the slide glass 8 may be used.

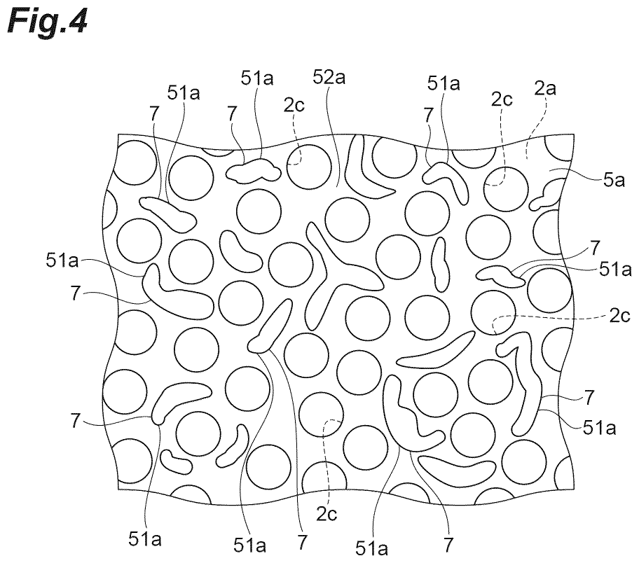

FIG. 4 is an enlarged view of the measurement region R when viewed from the first main surface 2a side of the substrate 2. As illustrated in FIG. 4, the sample support body 1 includes a plurality of absorption portions 7. The plurality of absorption portions 7 are provided on the surface 5a of the conductive layer 5. The absorption portion 7 is provided at least in each of the measurement region R and the calibration region C.

The absorption portions 7 are scattered on the surface 5a of the conductive layer 5. Specifically, the surface 5a of the conductive layer 5 includes a plurality of first regions 51a and a second region 52a. The first regions 51a are separated from each other. The shapes of the first regions 51a are different from each other when viewed from the thickness direction D. The first regions 51a are irregularly distributed when viewed from the thickness direction D. The second region 52a is positioned between the first regions 51a. In the present embodiment, the second region 52a is a region other than the first regions 51a on the surface 5a of the conductive layer 5.

The absorption portion 7 is provided in the first region 51a. In the present embodiment, the absorption portions 7 are provided in the first regions 51a, and the absorption portion 7 is not provided in the second region 52a. In other words, each of the first regions 51a is a region of the surface 5a of the conductive layer 5 where the absorption portion 7 is provided. The second region 52a is a region of the surface 5a of the conductive layer 5 where the absorption portion 7 is not provided. The second region 52a is exposed.

The first region 51a and the second region 52a are defined by the shape and distribution of the absorption portion 7. Since the absorption portion 7 is provided on a part of the surface 5a of the conductive layer 5, the area corresponding to the plurality of absorption portions 7 is smaller than the area corresponding to the conductive layer 5 when viewed from the thickness direction D. In FIGS. 1 and 2, illustration of the absorption portion 7 is omitted.

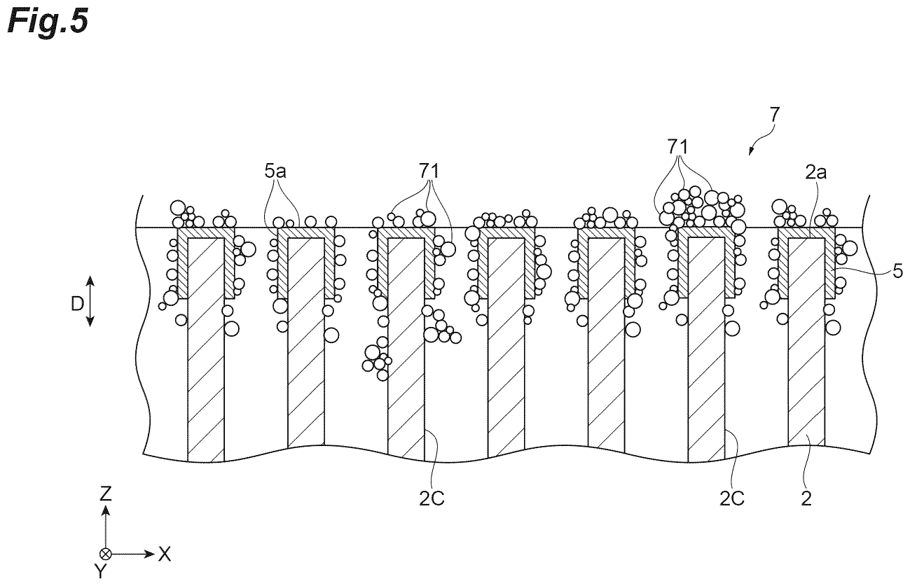

FIG. 5 is a cross-sectional view of a portion of the sample support body 1 where the absorption portion 7 exists. As illustrated in FIG. 5, the conductive layer 5 is formed on the first main surface 2a of the substrate 2 and a part of the inner wall surface of each hole 2c on the first main surface 2a side. The absorption portion 7 includes a plurality of particles 71. The plurality of particles 71 are deposited on the surface 5a of the conductive layer 5. The particles 71 are, for example, nanoparticles. The nanoparticle means a particle having a particle diameter smaller than a predetermined value. In the present embodiment, the average particle diameter of the particles 71 is about 5 nm to 1000 nm.

The average particle diameter of the particles 71 is a value acquired by a method of two-dimensionally observing the shape of the particles 71. The shape of the particle 71 is observed, for example, by a scanning electron microscope (SEM) or a scanning probe microscope (SPM). The average particle diameter of the particles 71 is acquired by image analysis on a two-dimensional image acquired by the microscope as described above or by directly measuring the length in an image observed by the microscope as described above. In the case of image analysis, for example, by performing binarization processing on the acquired image of the absorption portion 7, a plurality of pixel groups corresponding to the plurality of particles 71 are extracted, and the diameter of a circle having the average area of the plurality of particles 71 is acquired as the average particle diameter of the plurality of particles 71 based on the size per pixel.

In the case of directly measuring the length, the outer edge of the particle 71 is recognized based on the contrast difference of the particle boundary of the particle 71 in the image of the observed absorption portion 7, and then the particle diameter (actual size) of the particle 71 is acquired based on the length (pixel size) crossing the outer edge. In the case of directly measuring the length, both ends of the particle 71 may be recognized based on a one-dimensional profile representing the degree of unevenness of the surface of the particle 71 in the image of the observed absorption portion 7, and then the particle diameter (actual size) of the particle 71 may be acquired based on the length (pixel size) between the both ends. When the length is directly measured, the particle diameters of the plurality of particles 71 are acquired as described above, and then a statistical average value or median value is acquired as the average particle diameter of the particles 71. As a result of the shape observation, when the plurality of particles 71 form an aggregate, the particle diameter of each particle 71 included in the aggregate is measured. In the present embodiment, the average particle diameter (about 5 nm to 1000 nm) of the particles 71 is a value acquired by any of the above methods.

The plurality of particles 71 are distributed so as to partially cover the conductive layer 5. Specifically, the plurality of particles 71 are distributed on the surface 5a of the conductive layer 5 formed on the first main surface 2a, the surface 5a of the conductive layer 5 formed on the inner wall surface of each hole 2c, and the portion of the inner wall surface of each hole 2c exposed from the conductive layer 5. The plurality of particles 71 may not completely cover the conductive layer 5. A part of the conductive layer 5 may be exposed from the plurality of particles 71. The plurality of particles 71 do not block each hole 2c. The plurality of particles 71 may block a part of the hole 2c. The plurality of particles 71 may completely block some of the holes 2c. The plurality of particles 71 may not block all the holes 2c.

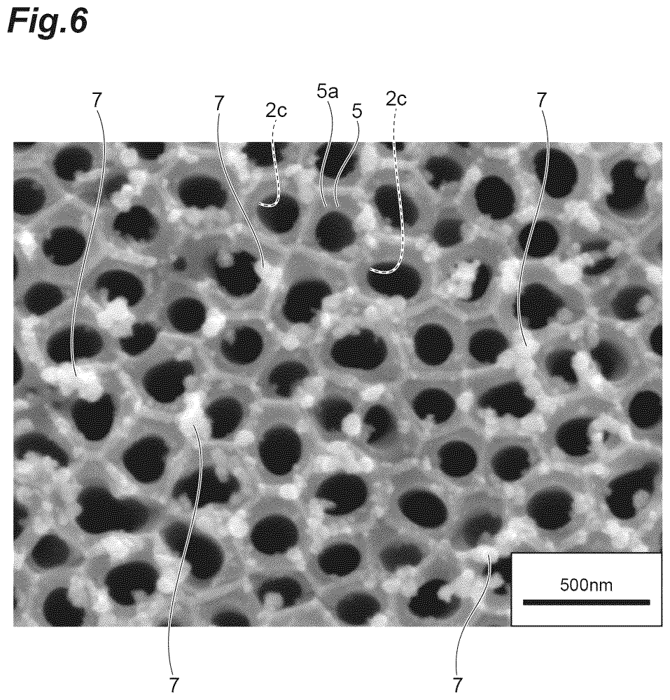

FIG. 6 illustrates an example of an SEM image of a part of the sample support body 1 provided with the absorption portion 7. In the SEM image, a black portion is the hole 2c, a gray portion is the conductive layer 5 formed on the surface of the partition wall between the holes 2c, and a white portion is the absorption portion 7. As illustrated in FIG. 6, the plurality of absorption portions 7 are scattered on the surface 5a of the conductive layer 5. The absorption portions 7 are attached to the surface 5a of the conductive layer 5.

The plurality of particles 71 have absorbability with respect to an energy beam used for ionization of the component of the sample S. That is, the absorption rates of the plurality of particles 71 with respect to the energy beam are comparatively large. The absorption rate of the plurality of particles 71 with respect to the energy beam is equal to or higher than the absorption rate of the conductive layer 5 with respect to the energy beam. In the present embodiment, the absorption rate of the plurality of particles 71 with respect to the energy beam is larger than the absorption rate of the conductive layer 5 with respect to the energy beam. The plurality of particles 71 exhibit a sensitizing action with respect to the energy beam. The sensitizing action of the plurality of particles 71 with respect to the energy beam is equivalent to the sensitizing action of the conductive layer 5 with respect to the energy beam or larger than the sensitizing action of the conductive layer 5 with respect to the energy beam. In the present embodiment, the energy beam is laser light. That is, the plurality of particles 71 has absorbability with respect to laser light.

The plurality of particles 71 have conductivity. As a result, since a voltage can be applied not only to the conductive layer 5 but also to the particles 71, energy transmission to the components of the sample on the first main surface 2a side can be reliably realized. The material of the plurality of particles 71 is different from the material of the conductive layer 5. The material of the plurality of particles 71 includes a metal element. In the present embodiment, the material of the plurality of particles 71 is Au.

The plurality of particles 71 are formed by an electrostatic spraying method. Specifically, first, a liquid (particle dispersion liquid) including the plurality of particles 71 is jetted (sprayed) onto the surface 5a of the conductive layer 5. Subsequently, the liquid adhering to the surface 5a of the conductive layer 5 is dried. As a result, each absorption portion 7 formed by the plurality of particles 71 is formed on the surface 5a of the conductive layer 5.

[Mass Spectrometry Method] Next, an example of a mass spectrometry method by using the sample support body 1 is described.

First, the above-described sample support body 1 is prepared in advance. Subsequently, the sample is introduced into each hole 2c. The sample is introduced into each hole 2c, for example, by pressing the measurement region R against a sample applied to human skin. That is, the sample is transferred to the measurement region R. The sample may be introduced into each hole 2c, for example, by dropping the sample into the measurement region R.

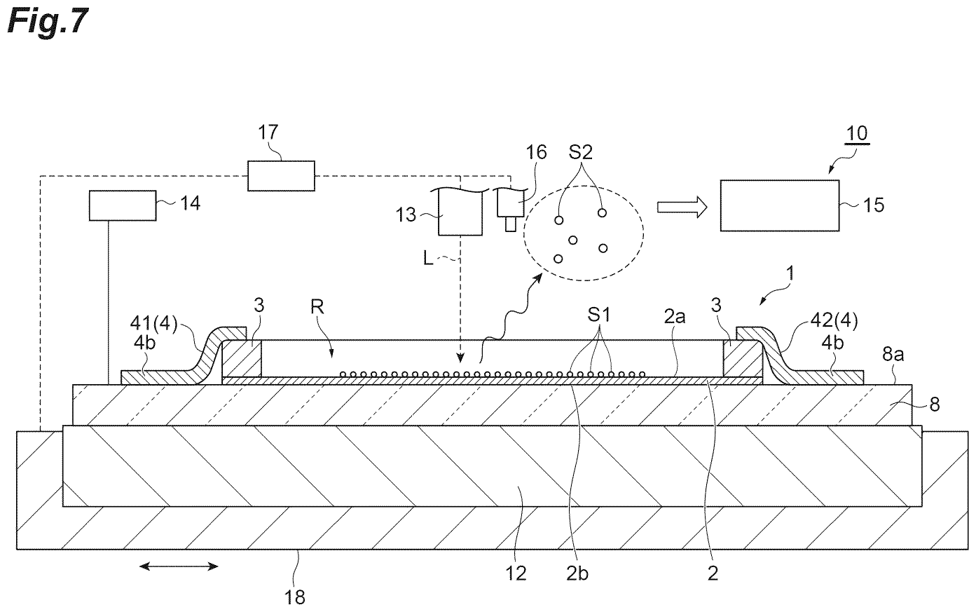

When the sample is transferred to the measurement region R, since the sample support body 1 is reinforced by the slide glass 8, breakage of the sample support body 1 (particularly, the substrate 2) can be effectively inhibited. Subsequently, as illustrated in FIG. 7, the sample support body 1 is placed on a support unit 12 of a mass spectrometer 10 in a state of being integrated with the slide glass 8 in advance. Note that, in FIG. 7, illustration of the hole 2c, the conductive layer 5, the adhesive layer 6, and the absorption portions 7 is omitted.

The mass spectrometer 10 includes the support unit 12, a sample stage 18, a camera 16, an irradiation unit 13, a voltage application unit 14, an ion detection unit 15, and a control unit 17. The support unit 12 is placed on the sample stage 18. The irradiation unit 13 irradiates the first main surface 2a of the sample support body 1 with energy beam L. The voltage application unit 14 applies a voltage to the first main surface 2a of the sample support body 1. The ion detection unit 15 detects sample ions S2. The camera 16 acquires a camera image including an irradiation position of the energy beam L by the irradiation unit 13. The camera 16 is, for example, a small CCD camera accompanied by the irradiation unit 13.

The control unit 17 controls operations of the sample stage 18, the camera 16, the irradiation unit 13, the voltage application unit 14, and the ion detection unit 15. The control unit 17 is, for example, a computer device including a processor (for example, a CPU), a memory (for example, a ROM or a RAM), and the like.

Subsequently, the voltage application unit 14 applies a voltage to the conductive layer 5 (see FIG. 2) of the sample support body 1 via the placement surface 8a of the slide glass 8 and the conductive tape 4. Subsequently, the control unit 17 operates the irradiation unit 13 based on the image acquired by the camera 16. Specifically, the control unit 17 operates the irradiation unit 13 so that the first main surface 2a in a laser irradiation range (for example, a region of the measurement region R where a component S1 identified based on the image acquired by the camera 16 exists) is irradiated with the energy beam L.

As an example, the control unit 17 moves the sample stage 18 and controls an irradiation operation (irradiation timing or the like) of the energy beam L by the irradiation unit 13. That is, the control unit 17 confirms that the sample stage 18 moves at a predetermined interval and then causes the irradiation unit 13 to perform irradiation with the energy beam L. For example, the control unit 17 repeats the movement (scanning) of the sample stage 18 and the irradiation with the energy beam L by the irradiation unit 13 to perform a raster scan within the laser irradiation range. Note that the irradiation position on the first main surface 2a may be changed by moving the irradiation unit 13 instead of the sample stage 18 or may be changed by moving both the sample stage 18 and the irradiation unit 13.

In this manner, the first main surface 2a in the laser irradiation range is irradiated with the energy beam L while a voltage is applied to the conductive layer 5, whereby the component S1 attached to the measurement region R is ionized. As a result. The sample ions S2 are released. Specifically, the energy is transmitted from the conductive layer 5 that absorbs the energy of the energy beam L to the components S1 that is attached to the measurement region R, and the components S1 that acquires the energy is vaporized and acquires charges to become the sample ions S2. The above-described steps correspond to an ionization method (herein, as an example, a laser desorption ionization method as a part of the mass spectrometry method) of the components S1 of the sample using sample support body 1.

The released sample ions S2 move while accelerating toward a ground electrode (not illustrated) provided between the sample support body 1 and the ion detection unit 15. That is, the sample ions S2 move while accelerating toward the ground electrode due to a potential difference generated between the ground electrode and the conductive layer 5 to which the voltage is applied. Here, the sample ions S2 are detected by the ion detection unit 15.

A detection result of the sample ions S2 by the ion detection unit 15 is associated with the irradiation position of the energy beam L. Specifically, the ion detection unit 15 detects the sample ions S2 for each individual position in the laser irradiation range. Consequently, a distribution image (MS mapping data) indicating a mass distribution of the sample S is acquired. Further, a two-dimensional distribution of molecules configuring the sample S can be imaged. That is, mass spectrometry imaging can be performed. Note that the mass spectrometer 10 herein is a mass spectrometer using time-of-flight mass spectrometry (TOF-MS).

As described above, the sample support body 1 includes the substrate 2 having the first main surface 2a and the plurality of holes 2c opened to the first main surface 2a. When the component S1 of the sample is introduced into the plurality of holes 2c, the component S1 remains on the first main surface 2a side. When the first main surface 2a is irradiated with the energy beam L while a voltage is applied to the conductive layer 5, energy is transmitted to the component S1 on the first main surface 2a side. The component S1 on the first main surface 2a side is ionized by this energy. Here, the plurality of particles 71 are provided on the surface 5a of the conductive layer 5. The absorption rate of the plurality of particles 71 with respect to the energy beam L is equal to or higher than the absorption rate of the conductive layer 5 with respect to the energy beam L. Therefore, the energy is efficiently transmitted to the component S1 on the first main surface 2a side, whereby the component S1 on the first main surface 2a side is efficiently ionized. Therefore, the signal intensity of the sample ions S2 generated by the ionization of the component S1 is improved. Therefore, with respect to the sample support body 1, highly sensitive mass spectrometry becomes possible.

The plurality of particles 71 are a plurality of nanoparticles deposited on the surface 5a of the conductive layer 5. As a result, the energy is more efficiently transmitted to the component S1 on the first main surface 2a side, and thus more sensitive mass spectrometry becomes possible.

The area corresponding to the plurality of particles 71 is smaller than the area corresponding to the conductive layer 5 when viewed from the thickness direction D. As a result, the functions of both the conductive layer 5 and the particles 71 can be reliably secured, and thus highly sensitive mass spectrometry as described above can be reliably realized. Specifically, according to this configuration, a part of the conductive layer 5 is exposed, and thus the component S1 of the sample can be brought into contact with both the conductive layer 5 and the particles 71. As a result, energy can be transmitted to the component S1 of the sample via the particles 71 while a voltage is applied to the component S1 of the sample via the conductive layer 5.

The surface 5a of the conductive layer 5 includes the plurality of first regions 51a separated from each other and the second region 52a positioned between plurality of first regions 51a. The plurality of particles 71 are provided in the plurality of first regions 51a. The second region 52a is not provided with the plurality of particles 71. As a result, as described above, the functions of both the conductive layer 5 and the particles 71 can be reliably secured, and thus highly sensitive mass spectrometry can be reliably realized.

The plurality of particles 71 has absorbability with respect to laser light. As a result, by using the laser light as the energy beam L, it is possible to realize the highly sensitive mass spectrometry as described above.

The sensitizing action of the plurality of particles 71 with respect to the energy beam L is larger than the sensitizing action of the conductive layer 5 with respect to the energy beam L. As a result, the highly sensitive mass spectrometry as described above can be reliably realized.

The material of the plurality of particles 71 is different from the material of the conductive layer 5. As a result, the degree of freedom in selecting the respective materials of the conductive layer 5 and the particles 71 can be improved while securing the functions of both the conductive layer 5 and the particles 71.

The material of the plurality of particles 71 includes a metal element. As a result, the degree of freedom in selecting the material of the particles 71 can be improved while securing the function of the particles 71 having absorbability with respect to the energy beam L.

The material of the plurality of particles 71 is Au. As a result, the degree of freedom in selecting the material of the particles 71 can be improved while securing the function of the particles 71 having absorbability with respect to the energy beam L.

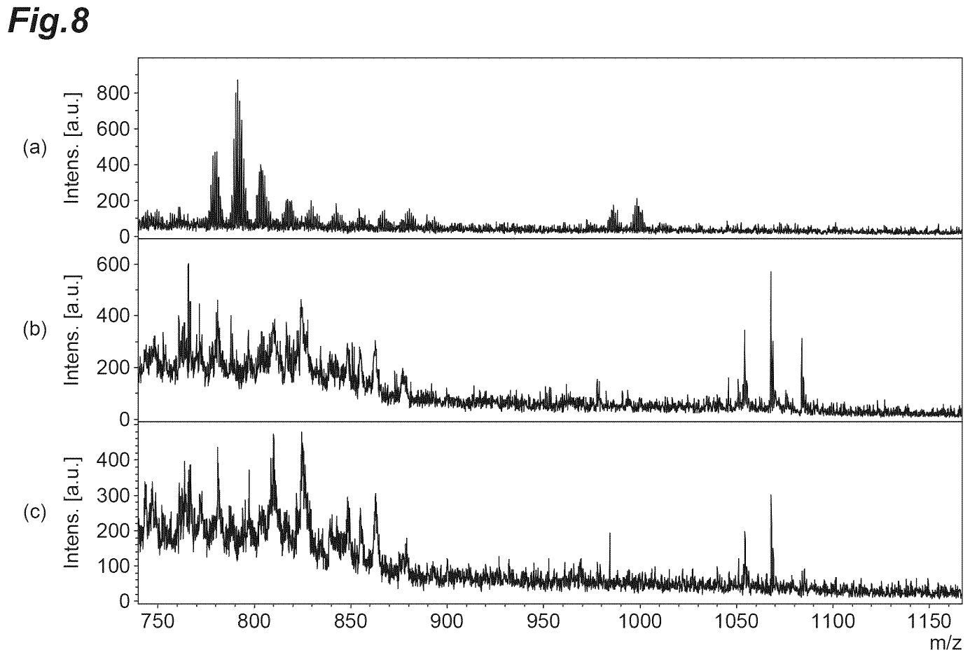

The plurality of particles 71 are formed by an electrostatic spraying method. As a result, the function of the particles 71 having absorbability with respect to the energy beam L can be secured at low cost. In addition, aggregation of the particles 71 can be inhibited, and the state of the particles 71 formed on the surface 5a of the conductive layer 5 as particles can be secured. In addition, the plurality of particles 71 can be evenly distributed on the surface 5a of the conductive layer 5.

[Examples] (a) of FIG. 8 is a diagram illustrating a mass spectrum obtained by a mass spectrometry method of a first comparative example. Each of (b) and (c) of FIG. 8 is a diagram illustrating a mass spectrum obtained by the mass spectrometry method of the first example. A sample support body used in the mass spectrometry method of the first comparative example is different from the sample support body 1 in that the sample support body does not include the particles 71. In the mass spectrometry of the first comparative example, the intensity of the laser light was set to 75%. In the first example, the sample support body 1 ((b) of FIG. 8) in which the material of the particles 71 is Pt and the sample support body 1 ((c) of FIG. 8) in which the material of the particles 71 is Au were used. In the first example, the intensity of the laser light was set to 50%. The rest of the mass spectrometry method of the first comparative example is the same as the mass spectrometry method of the first example. In the first comparative example and the first example, Angiotensin II was used as a sample.

As illustrated in (a) to (c) of FIG. 8, although the intensity of the laser light in the first example is smaller than the intensity of the laser light in the first comparative example, the detection intensity of ions in the mass spectrometry method of the first example is larger than the detection intensity of ions in the mass spectrometry method of the first comparative example, in a region of about m/z 1050 to 1100. As described above, it was found that the sample support body 1 enables highly sensitive mass spectrometry.

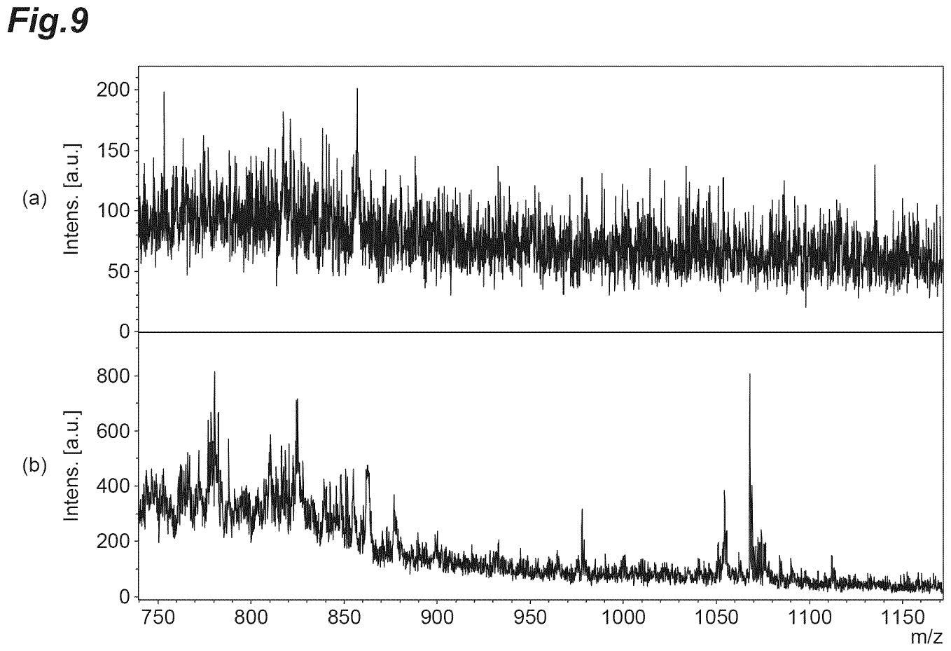

(a) of FIG. 9 is a diagram illustrating a mass spectrum obtained by a mass spectrometry method of a second comparative example. (b) of FIG. 9 is a diagram illustrating a mass spectrum obtained by a mass spectrometry method of a second example. A sample support body used in the mass spectrometry method of the second comparative example is different from the sample support body 1 in that the sample support body does not include the particles 71. In the mass spectrometry of the second comparative example, the intensity of the laser light was set to 80%. In the second example, the sample support body 1 in which the material of the particles 71 is Pt was used. In the second example, the intensity of the laser light was set to 55%. The rest of the mass spectrometry method of the second comparative example is the same as the mass spectrometry method of the second example. In the second comparative example and the second example, Angiotensin II was used as a sample.

As illustrated in (a) and (b) of FIG. 9, although the intensity of the laser light in the second example is smaller than the intensity of the laser light in the second comparative example, the detection intensity of ions in the mass spectrometry method of the second example is larger than the detection intensity of ions in the mass spectrometry method of the second comparative example, in a region of about m/z 1050 to 1100. As described above, it was found that the sample support body 1 enables highly sensitive mass spectrometry.

As illustrated in FIG. 8 or 9, the sample support body 1 enables highly sensitive mass spectrometry even when the intensity of the energy beam is comparatively small. As a result, it is possible to perform highly sensitive mass spectrometry while inhibiting damage of the component S1 of the sample as the measurement target object due to irradiation with the energy beam. That is, highly sensitive mass spectrometry becomes possible while realizing softer ionization of the component S1 of the sample.

[Method for Manufacturing Sample support body] Next, a method for manufacturing the sample support body 1 is described.

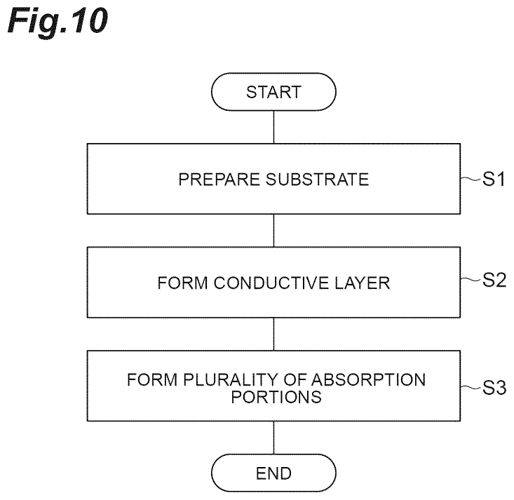

As illustrated in FIG. 10, first, the substrate 2 is prepared (Step S1, First step). The substrate 2 is prepared in a state of being adhered to the frame 3 by the adhesive layer 6. Subsequently, the conductive layer 5 is provided on the first main surface 2a of the substrate 2 (Step S2, Second step). In step S2, the conductive layer 5 is formed, for example, by a known vapor deposition method. In step S2, Pt is deposited on the heated substrate 2. As a result, flatness of the surface 5a of the conductive layer 5 can be secured. In step S2, Pt is deposited, for example, under a condition that the degree of vacuum is about 10-4 Pa. In step S2, the conductive layer 5 is provided so as not to block the hole 2c.

Subsequently, the plurality of absorption portions 7 are provided on the surface 5a of the conductive layer 5 (Step S3, Third step). In step S3, the plurality of absorption portions 7 are provided by a wet process. In step S3, the plurality of absorption portions 7 are provided, for example, by an electrostatic spraying method. Specifically, in step S3, the liquid containing the plurality of particles 71 is formed into fine droplets by using electrostatic spraying and also is jetted (sprayed) to the surface 5a of the conductive layer 5. As a result, the plurality of particles 71 can be provided on the surface 5a of the conductive layer 5 while inhibiting aggregation of the plurality of particles 71.

In step S3, the liquid containing the plurality of particles 71 is jetted to at least the surface 5a of the conductive layer 5 provided in each of the measurement region R and the calibration region C. In the electrostatic spraying method in step S3, for example, an electrostatic spraying film forming device manufactured by Hamamatsu Nano Technology Inc. is used. Subsequently, the liquid adhering to the surface 5a of the conductive layer 5 is dried. As a result, the absorption portions 7 including the particles 71 are formed on the surface 5a of the conductive layer 5.

As described above, according to the method for manufacturing the sample support body 1, the sample support body 1 that enables highly sensitive mass spectrometry can be manufactured as described above.

In step S3, the plurality of particles 71 are provided by a wet process. As a result, the particles 71 having absorbability with respect to the energy beam L can be reliably formed.

In step S3, the liquid containing the plurality of particles 71 is jetted onto the surface 5a of the conductive layer 5 by an electrostatic spraying method. As a result, the particles 71 having absorbability with respect to the energy beam L can be reliably formed at low cost. In addition, aggregation of the particles 71 can be inhibited, and the state of the particles 71 formed on the surface 5a of the conductive layer 5 as particles can be secured. In addition, the plurality of particles 71 can be evenly distributed on the surface 5a of the conductive layer 5.

[Modifications] The embodiments of the present disclosure are described above, but the present disclosure is not limited to the above-described embodiments. The material and shape of each configuration are not limited to the material and shape described above, and various materials and shapes can be adopted.

The conductive layer 5 may be configured, for example, with a plurality of particles. In this case, the density of the plurality of particles in the conductive layer 5 is larger than the density of the plurality of particles 71 in the absorption portion 7. The density refers to a ratio of a volume of particles to a volume of a space when a plurality of particles exist in the space having a predetermined volume. For example, as the number of particles existing in the space increases, the density of particles tends to increase. For example, as the volume of the gap between the particles existing in the space decreases, the density of the particles tends to increase. The plurality of particles in the conductive layer 5 are more densely assembled than the plurality of particles 71 in the absorption portion 7. The average particle diameter of the plurality of particles 71 in the absorption portion 7 is larger than the average particle diameter of the plurality of particles in the conductive layer 5. The average particle diameter of the plurality of particles in the conductive layer 5 is acquired by a similar method for the plurality of particles 71 in the absorption portion 7. According to such a configuration, the energy beam L can be efficiently absorbed without increasing the thickness of the conductive layer 5. Specifically, with the sample support body 1, since the function of conductivity is secured by the conductive layer 5, and further the function of absorption of the energy beam L is secured by the absorption portion 7, the thickness of the conductive layer 5 can be set to a minimum value required for securing conductivity. The sum of the thickness of the conductive layer 5 and the thicknesses of the plurality of absorption portions 7 may be, for example, smaller than 30 nm.

In the embodiment, an example in which the material of the plurality of particles 71 is Au is described, but the material of the plurality of particles 71 may be, for example, Pt. That is, the material of the plurality of particles 71 may be the same as the material of the conductive layer 5. In this case, the material of the conductive layer 5 and the material of the plurality of particles 71 can be made common, and the configuration of the sample support body 1 is simplified. In addition, when the liquid including the sample is dropped in the region of the measurement region R where the absorption portion 7 is provided, the visibility of the region of the measurement region R where the liquid is dropped can be improved. The material of the plurality of particles 71 may be Pd (palladium). The plurality of particles 71 may be capable of occluding hydrogen. The absorption rate of Pd with respect to the energy beam L is larger than the absorption rate of Pt with respect to the energy beam L. When the material of the plurality of particles 71 is Pd, a process of occluding hydrogen (a process of exposing the particles to a hydrogen gas atmosphere) may be performed on the plurality of particles 71. Examples of the material of the plurality of particles 71 may include magnesium (Mg), aluminum (Al), titanium (Ti), iron (Fe), nickel (Ni), zirconium (Zr), niobium (Nb), molybdenum (Mo), tantalum (Ta), lanthanum (La), cerium (Ce), thorium (Th), or an alloy including these, as a material capable of occluding hydrogen. Even in such a case, the process of occluding hydrogen may be performed on the plurality of particles 71.

The material of the plurality of particles 71 may be, for example, TiO2 (titanium dioxide). In this case, the degree of freedom in selecting the material of the particles 71 can be improved while securing the function of the particles 71 having absorbability with respect to the energy beam L.

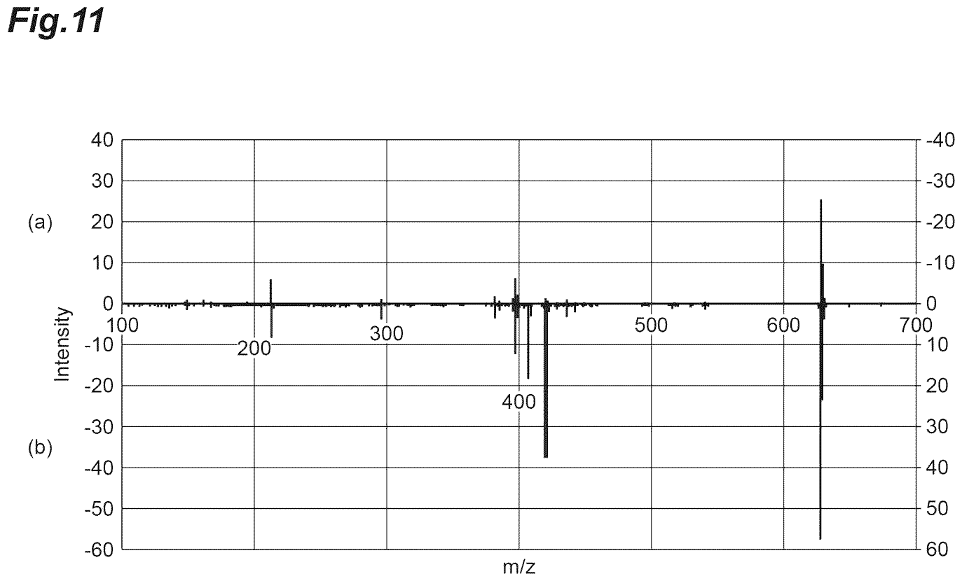

(a) of FIG. 11 is a diagram illustrating a mass spectrum obtained by a mass spectrometry method of a third comparative example. (b) of FIG. 11 is a diagram illustrating a mass spectrum obtained by a mass spectrometry method of a third example. A sample support body used in the mass spectrometry method of the third comparative example is different from the sample support body 1 in that the sample support body does not include the particles 71. In the third example, the sample support body 1 in which the material of the particles 71 is TiO2 was used. The rest of the mass spectrometry method of the third comparative example is the same as the mass spectrometry method of the third example. In the third comparative example and the third example, the sunscreen cream applied to the human skin was transferred to the measurement region R. The intensity of the laser light in the third comparative example was the same as the intensity of the laser light in the third example.

As illustrated in (a) and (b) of FIG. 11, in a region around m/z 630, the detection intensity of ions in the mass spectrometry method of the third example is larger than the detection intensity of ions in the mass spectrometry method of the third comparative example. As described above, it was found that the sample support body 1 enables highly sensitive mass spectrometry.

The material of the plurality of particles 71 may include carbon. The material of the plurality of particles 71 may be a compound including a metal element or carbon. In the embodiment, an example in which the plurality of particles 71 have conductivity is described, but the plurality of particles 71 may have insulating properties. The plurality of particles 71 may have semiconductor properties. In these cases, the degree of freedom in selecting the material of the particles 71 can be improved while securing the function of the particles 71 having absorbability with respect to the energy beam L. The plurality of particles 71 may have absorbability with respect to the energy beam L used for ionization of the component S1 of the sample S.

The plurality of particles 71 may have absorbability to ultraviolet rays. As a result, the range of the wavelength band of the energy beam L is widened, and thus the degree of freedom in selecting the type of the energy beam L can be improved.

In the embodiment, an example in which the absorption portions 7 are scattered on the surface 5a of the conductive layer 5 is described, but the plurality of particles 71 may cover the surface 5a of the conductive layer 5. That is, at least the entire surface 5a of the conductive layer 5 provided in the measurement region R or the calibration region C may be covered with the plurality of particles 71. The surface 5a of the conductive layer 5 may not be exposed.

In the embodiment, the example in which the plurality of particles 71 is formed by the electrostatic spraying method as an example of the wet process is described, but the plurality of particles 71 may be formed, for example, by another wet process. The plurality of particles 71 may be formed, for example, by an ultrasonic spraying method. In this case, as in the electrostatic spraying method, the plurality of particles 71 can be evenly distributed on the surface 5a of the conductive layer 5.

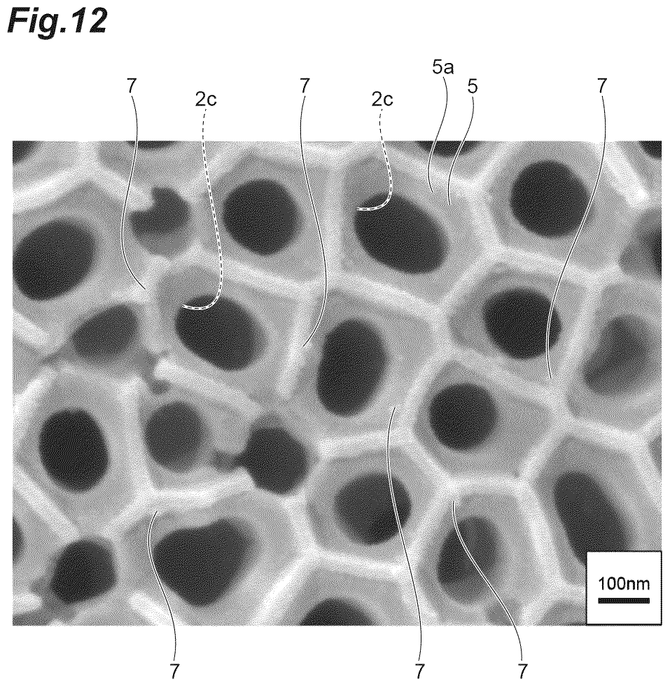

The plurality of particles 71 may be formed by dropping or dip coating using a particle dispersion liquid containing the plurality of particles 71. In this case, the thickness of the absorption portion 7 can be secured by performing the dropping or dip coating a plurality of times. FIG. 12 is an enlarged image of the absorption portion 7 formed by the dropping onto the surface 5a of the conductive layer 5. As illustrated in FIG. 12, the plurality of absorption portions 7 are provided on the surface 5a of the conductive layer 5.

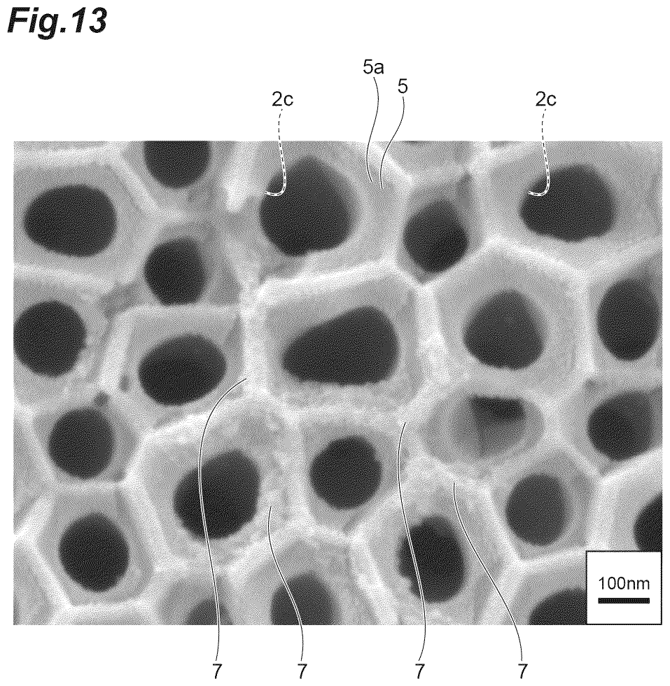

The plurality of particles 71 may be formed by spin coating using the particle dispersion liquid containing the plurality of particles 71. FIG. 13 is an enlarged image of the absorption portion 7 formed by the spin coating on the surface 5a of the conductive layer 5. As illustrated in FIG. 13, the plurality of absorption portions 7 are provided on the surface 5a of the conductive layer 5.

The plurality of particles 71 may be formed by a dry process. The plurality of particles 71 may be formed, for example, by magnetron sputtering, spark ablation, pulsed vacuum arc deposition, or the like.

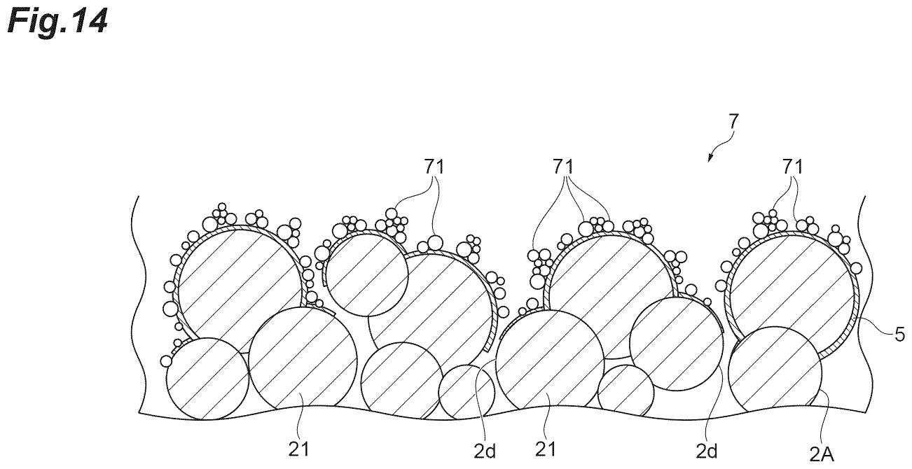

In the embodiment, an example in which each hole 2c extends along the thickness direction D of the substrate 2 and is uniformly formed in the substrate 2 is described, but the substrate 2 may have, for example, an irregular porous structure. Specifically, the sample support body 1 may include a substrate 2A illustrated in FIG. 14 instead of the substrate 2. As illustrated in FIG. 14, the substrate 2A is, for example, a sintered body of glass beads or the like. The glass bead sintered body has, for example, a structure in which a large number of glass beads 21 are integrated by sintering. The shape and size of each glass bead 21 included in the substrate 2A may be uniform or irregular. Each hole 2d of the substrate 2A is a gap formed between the glass beads. Each hole 2d extends in an irregular direction and is irregularly distributed in three dimensions. The holes 2d irregularly communicate with each other. Therefore, for example, the liquid in contact with one main surface of the substrate 2A can move toward the other side of the substrate 2A following a plurality of paths (respective holes 2d) formed inside the substrate 2A. Each hole 2d may not penetrate the substrate 2A. Each hole 2d may be open to one main surface of the substrate 2A and may not be open to the other main surface of the substrate 2A.

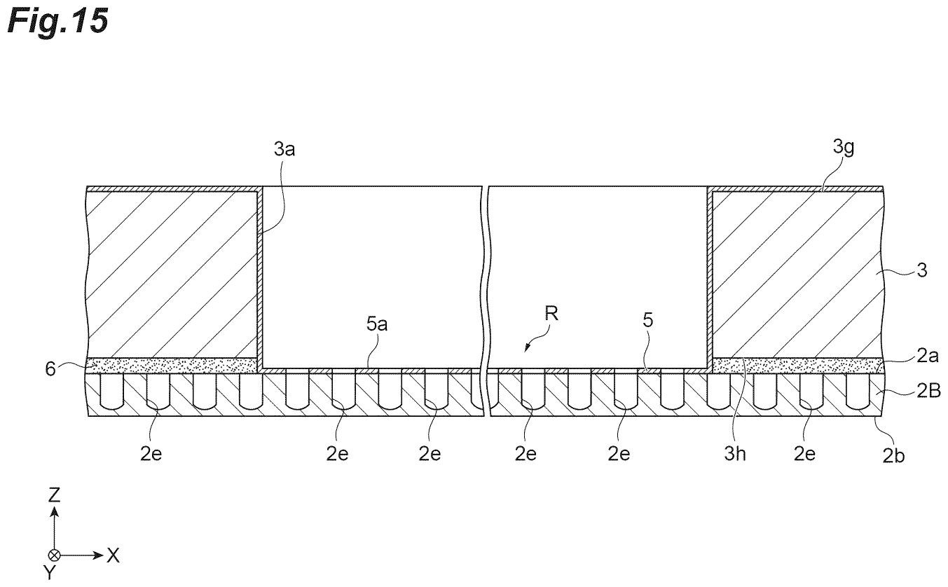

In the embodiment, an example in which each hole 2c penetrates the substrate 2 is described, but each hole 2c may not penetrate the substrate 2. Specifically, the sample support body 1 may include a substrate 2B illustrated in FIG. 15 instead of the substrate 2. As illustrated in FIG. 15, the substrate 2B is different from the substrate 2 in that the substrate 2B includes a plurality of holes 2e instead of the plurality of holes 2c. Each hole 2e does not penetrate the substrate 2B. Each hole 2e is open to the first main surface 2a and is not open to the second main surface 2b. The substrate 2B may be, for example, an anodized alumina porous film used for SALDI.

### REFERENCE SIGNS LIST

1 sample support body
2, 2A, 2B substrate
2a first main surface
2c hole
5 conductive layer
5a surface
51a first region
52a second region
71 particle
L energy beam
S1 sample component

1. A sample support body used for ionizing a component of a sample, the sample support body comprising:
a substrate configured to include a main surface and a plurality of holes opened in the main surface;
a conductive layer configured to be provided on the main surface so as not to block the holes; and
a plurality of particles configured to be provided on a surface of the conductive layer,
wherein an absorption rate of the plurality of particles with respect to an energy beam used for the ionization is equal to or higher than an absorption rate of the conductive layer with respect to the energy beam.

2. The sample support body according to claim 1, wherein the plurality of particles are a plurality of nanoparticles deposited on the surface of the conductive layer.

3. The sample support body according to claim 1, wherein an area corresponding to the plurality of particles is smaller than an area corresponding to the conductive layer when viewed from a direction perpendicular to the main surface.

4. The sample support body according to claim 3, wherein
the surface of the conductive layer includes a plurality of first regions separated from each other and a second region positioned between the plurality of first regions,
the plurality of particles are provided in each of the plurality of first regions, and
the plurality of particles are not provided in the second region.

5. The sample support body according to claim 1, wherein the plurality of particles have absorbability for laser light.

6. The sample support body according to claim 1, wherein the plurality of particles have absorbability for ultraviolet rays.

7. The sample support body according to claim 1, wherein a sensitizing action of the plurality of particles with respect to the energy beam is greater than a sensitizing action of the conductive layer with respect to the energy beam.

8. The sample support body according to claim 1, wherein a material of the plurality of particles is different from a material of the conductive layer.

9. The sample support body according to claim 1, wherein a material of the plurality of particles includes a metal element.

10. The sample support body according to claim 9, wherein a material of the plurality of particles is gold, platinum, or titanium dioxide.

11. The sample support body according to claim 1, wherein a material of the plurality of particles includes carbon.

12. The sample support body according to claim 1, wherein a material of the plurality of particles is a compound including a metal element or carbon.

13. The sample support body according to claim 1, wherein the plurality of particles are formed by an electrostatic spraying method.

14. A method for manufacturing a sample support body used for ionizing a component of a sample, the method comprising:
a first step of preparing a substrate that includes a main surface and a plurality of holes opened in the main surface;
a second step of providing a conductive layer on the main surface so as not to block the holes; and
a third step of providing a plurality of particles on a surface of the conductive layer,
wherein an absorption rate of the plurality of particles with respect to an energy beam used for the ionization is equal to or higher than an absorption rate of the conductive layer with respect to the energy beam.

15. The method for manufacturing a sample support body according to claim 14, wherein in the third step, the plurality of particles are provided by a wet process.

16. The method for manufacturing a sample support body according to claim 15, wherein in the third step, a liquid including the plurality of particles is jetted onto the surface of the conductive layer by an electrostatic spraying method.
